(19) United States
(12) Patent Application Publication
(10) Pub. No.: US 2006/0107257 A1
(43) Pub. Date: May 18, 2006

(54) Executing a native software routine in a virtual machine

(76) Inventor: Timothy P. Ellison, Winchester (GB)

Correspondence Address: IBM CORPORATION;INTELLECTUAL PROPERTY LAW, 11400 BURNET ROAD, AUSTIN, TX, 78758, US

(21) Appl. No.: 11/242,672

(22) Filed: Oct. 3, 2005

(30) Foreign Application Priority Data
Nov. 10, 2004 (GB) 0424756.5

(51) Int. Cl. G06F 9/45

(52) U.S. Cl. 717/148

(57) ABSTRACT

A method of executing a software routine in a virtual machine executing on a computer system, wherein the computer system can operate in one of a virtual machine execution context or a native execution context, the method comprising the steps of: identifying a declaration of the software routine, the declaration including an indication that the software routine is to be executed in a native binary form; responsive to a determination that the declaration of the software routine includes an indication that the software routine should be called directly by the virtual machine, the computer system operating in a virtual machine execution context and the virtual machine calling the software routine directly; executing the software routine in a native binary form.

### FIELD OF THE INVENTION

The present invention relates to executing a native software routine in a virtual machine. In particular; it relates to executing a native software routine without changing execution context.

### BACKGROUND OF THE INVENTION

Java (a trademark of Sun Microsystems, Inc.) is an object oriented programming language and execution environment allowing programmers to define software classes as encapsulated software components comprising data and functionality. The functionality within a Java class is represented by software methods which are executed by a Java virtual machine (JVM). A JVM is a virtual computer implemented as software on a computer system. A JVM includes components necessary to load Java classes and execute software methods written in the Java programming language.

Java classes are written in the Java programming language using Java instructions. Java instructions are subsequently encoded as platform independent bytecodes by a Java compiler and stored in binary Java class files until they are executed. On execution, the JVM loads a Java class file into memory and executes the software methods it contains. The JVM can also call software routines which exist as native code (e.g. functions within a native library such as a dynamic link library (DLL)). Native software routines are called through the Java Native Interface (JNI) which is documented in detail in the JNI 1.1 Specification available from Sun Microsystems on the world wide web at java.sun.com/j2se/1.4.2/docs/guide/jni/spec/jniTOC.html. When a JVM executes a software method using Java bytecodes, the software method is said to be running in the “Java context”. In the Java context the Java virtual machine interprets and executes Java bytecodes directly. In contrast, when the JVM executes a software method using a native software routine through the JNI, the software method is said to be running in the “native context”. In the native context a software method is not interpreted by the JVM. Rather, in the native context a software method executes as native machine code. The JNI is designed to allow native software routines in a Java application to access and manipulate non-native (i.e. Java) objects in the Java application. Access to the non-native objects, fields and methods is achieved through a set of accessor functions available to native software routines. However, when a native software routine executing in the native context accesses Java objects in this way it is necessary to switch from the native context to the Java context to access the Java object, and to subsequently return to the native context to continue executing the native software routine.

The use of JNI to incorporate native software routines into a Java -application has-the drawback that the Java application must endure frequent switches between the Java context and the native context during execution. It is therefore commonly accepted that programmers use native software routines to perform non-trivial tasks that overshadow the overhead of the JNI context switching. This is acknowledged in the JNI 1.1 Specification (Chapter 2, “Accessing Java Objects”). However, developing significant aspects of application logic for a Java application in native software routines in order to justify the use of the JNI is itself bound by disadvantages. In particular, a Java application which includes both Java and native software methods is difficult to debug since there is no single unified debug platform which allows a programmer to closely examine and monitor the execution of a combined Java and native application at runtime in order to diagnose and debug problems in application logic. Where native software routines are sufficiently small and insignificant that they can be ignored for the purposes of debugging, a Java debugger can be employed. However, since the inefficiencies of JNI context switching encourage the use of native software routines which include non-trivial and potentially substantial aspects of application logic, it is unlikely that the native software routines in a Java application can be ignored.

Thus it would be advantageous if the disadvantages of the JNI in terms of the need for context switching were overcome so that programmers are not encouraged to develop substantial aspects of application logic in native software routines. This would then allow programmers to develop application logic in Java code, using native software routines only where absolutely necessary, providing for more effective debugging of Java applications.

### SUMMARY OF TH INVENTION

The present invention accordingly provides, in a first aspect, a method of executing a software routine in a virtual machine executing on a computer system, wherein the computer system can operate in one of a virtual machine execution context or a native execution context, the method comprising the steps of: identifying a declaration of the software routine, the declaration including an indication that the software routine is to be executed in a native binary form; responsive to a determination that the declaration of the software routine includes an indication that the software routine should be called directly by the virtual machine, the computer system operating in a virtual machine execution context and the virtual machine calling the software routine directly; executing the software routine in a native binary form. Thus the virtual machine is able to call the software routine native code directly with no change of context. The ability to call the software routine native code without a change of context allows applications developers to use native code only where absolutely necessary whilst including application logic in bytecode (such as Java code). This further provides for more effective debugging of an application since substantive application logic can be contained within the application bytecode.

Preferably, the method further comprises: responsive to a determination that the declaration of the software routine does not include an indication that the software routine should be called directly by the virtual machine, the computer system operating in a native execution context, executing a proxy routine in a native binary form, wherein the proxy routine calls the software routine. Thus the virtual machine is able to call the software routine native code using a native interface such as the JNI which changes the execution context to the native execution context. This provides backwards compatibility where a virtual machine does not support directly calling the software routine natively.

The present invention accordingly provides, in a second aspect, apparatus for executing a software routine in a virtual machine executing on a computer system, wherein the computer system can operate in one of a virtual machine execution context or a native execution context, the apparatus comprising: means for identifying a declaration of the software routine, the declaration including an indication that the software routine is to be executed in a native binary form; means for responsive to a determination that the declaration of the software routine includes an indication that the software routine should be called directly by the virtual machine, the computer system operating in a virtual machine execution context and the virtual machine calling the software routine directly; means for executing the software routine in a native binary form.

The present invention accordingly provides, in a third aspect, a computer program product comprising computer program code stored on a computer readable storage medium which, when executed on a data processing system, instructs the data processing system to carry out the method described above.

The present invention accordingly provides, in a fourth aspect, a computer system comprising: a central processing unit; a storage; an input/output interface; and a means for executing a software routine in a virtual machine executing on a computer system as described above.

### BRIEF DESCRIPTION OF THE DRAWINGS

A preferred embodiment of the present invention will now be described, by way of example only, with reference to the accompanying drawings, in which:

FIG. 1 is a block diagram of a computer system suitable for the operation of embodiments of the present invention;

FIG. 2 is a block diagram of a computer system including a virtual machine executing an application in accordance with a preferred embodiment of the present invention;

FIG. 3 is a block diagram of the computer system of FIG. 2 including a virtual machine executing an application in accordance with a preferred embodiment of the present invention for a situation where the software routine of FIG. 2 is called directly by the virtual machine;

FIG. 4 is a block diagram of the computer system 200 of FIG. 2 including a virtual machine executing an application in accordance with a preferred embodiment of the present invention for a situation where the software routine of FIG. 2 is called using the native interface of FIG. 2; and

FIG. 5 is a flowchart illustrating a method for executing a native software routine in accordance with a preferred embodiment of the present invention.

### DETAILED DESCRIPTION OF THE PREFERRED EMBODIMENT

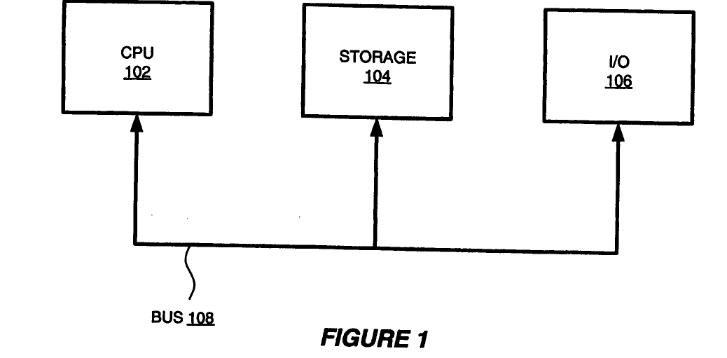

FIG. 1 is a block diagram of a computer system suitable for the operation of embodiments of the present invention. A central processor unit (CPU) 102 is communicatively connected to a storage 104 and an input/output (I/O) interface 106 via a data bus 108. The storage 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

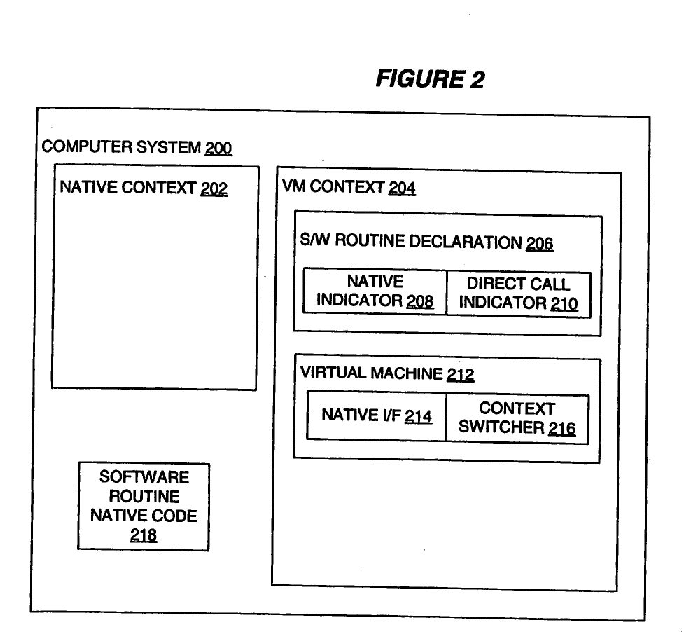

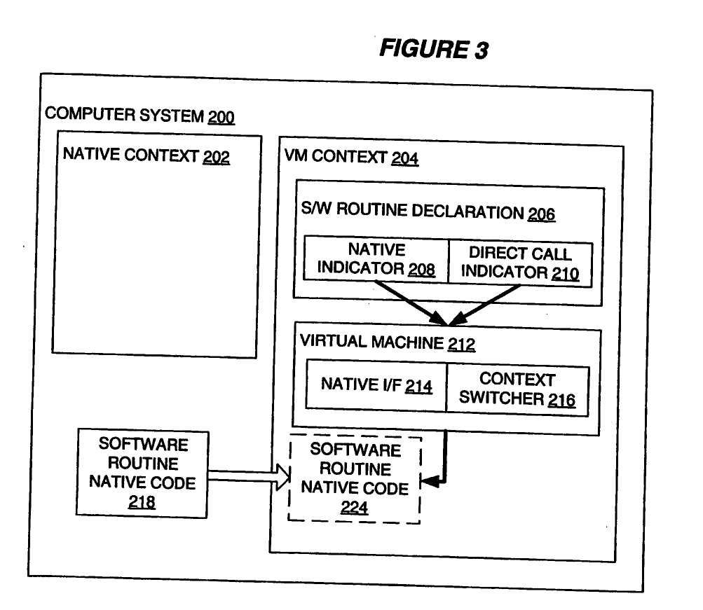

FIG. 2 is a block diagram of a computer system 200 including a virtual machine 212 executing an application in accordance with a preferred embodiment of the present invention. The computer system 200 is able to execute application code in one of two contexts: a native context 202; or a virtual machine context 204. In the native context 202 application code executes as native code such as machine code. In the virtual machine context 204 application code executes as bytecodes which are interpreted by a virtual machine 212. The virtual machine 212 itself executes as native code in the virtual machine context 204. An example of a virtual machine 212 is a Java virtual machine. The virtual machine 212 is able to call native software routines in two different ways. Firstly, the virtual machine 212 can make a direct call to a native software routine (this amounts to one native software routine calling another native software routine). In this way a called native software routine will execute in the virtual machine context 204 as is described below with reference to FIG. 3. Alternatively, the virtual machine 212 can invoke a native software routine using a native interface 214. When the native interface 214 is used to call a native software routine a context switcher 216 switches the context of the computer system 200 to the native context 202. Thus a native software routine called using the native interface 214 executes in the native context 202. An example of a native interface 214 is the Java Native Interface (JNI).

FIG. 2 further includes a representation of a software routine declaration 206 which provides information for a software method in a Java application. In particular, the software routine declaration 206 includes a native indicator 208 which indicates whether the software method is a native software routine comprised of native code or a software method comprised of bytecodes. In a preferred embodiment of the present invention the native indicator 208 is derived from the “native” modifier used in the Java programming language to indicate that a method is implemented in native code. Further, the software routine declaration 206 includes a direct call indicator 210 which indicates, for a native software routine, whether the native software routine should be called directly by the virtual machine 212 or whether the native software routine should be called using the native interface 214. In a preferred embodiment of the present invention the direct call indicator 210 is defined using metadata in the software routine declaration 206. Such metadata can be introduced into the software routine declaration 206 using code annotations, such as the ‘@’ character in Java release 5. Further, FIG. 2 includes software routine native code 218 for which the software routine 206 corresponds. Software routine native code 218 is a software routine in native code format, such as machine code.

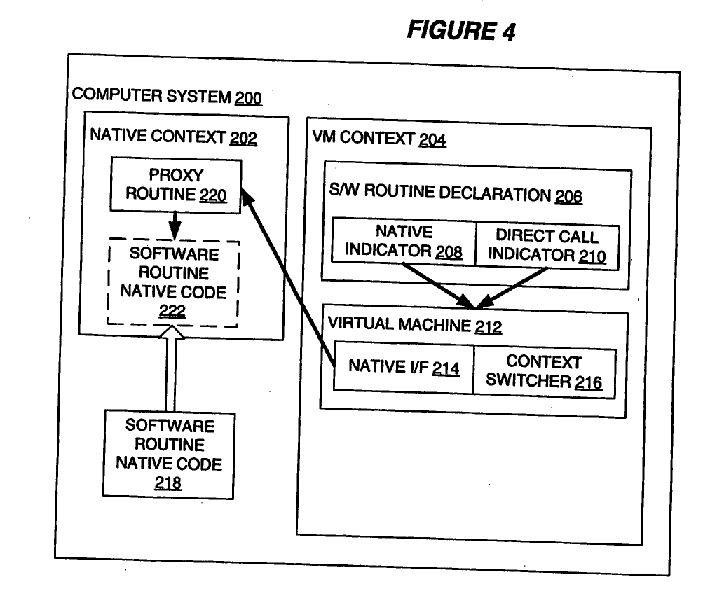

In use, the virtual machine 212 calls the software routine native code 218 by first referring to a corresponding software routine declaration 206. If the native indicator 208 indicates that the software routine is implemented in native code, then the virtual machine 212 uses the direct call indicator 210 to determine how the software routine native code 218 should be called. I.e. The software routine native code 218 can be called directly by the virtual machine 212, or alternatively the native interface 214 can be used. Each of these situations is considered in turn with reference to FIGS. 3 and 4 below.

FIG. 3 is a block diagram of the computer system 200 of FIG. 2 including a virtual machine 212 executing an application in accordance with a preferred embodiment of the present invention for a situation where the software routine 218 of FIG. 2 is called directly by the virtual machine 212. If the direct call indicator 210 includes an indication that the virtual machine 212 should call the software routine native code 218 directly, the software routine native code 218 executes within the virtual machine context 204 (as is indicated by software routine native code 224). In this case the native interface 214 is not used, and no switch from the virtual machine context 204 to the native context 202 takes place. This has the advantage that no overheads from context switching are experienced.

FIG. 4 is a block diagram of the computer system 200 of FIG. 2 including a virtual machine 212 executing an application in accordance with a preferred embodiment of the present invention for a situation where the software routine 218 of FIG. 2 is called using the native interface 214 of FIG. 2. If the direct call indicator 210 does not include an indication that the virtual machine 212 should call the software routine native code 218 directly, the virtual machine 212 employs the native interface 214 to switch to the native context 202 and execute the software routine native code 218. However, for a native software routine to be executed by the native interface 214 (such as JNI), the native software routine must be adapted to co-operate with the native interface 214. For example, the native software routine must accept arguments which provide access to Java objects, such as through accessor functions, as is well known in the art. However, the software routine native code 218 is not so adapted and it is therefore necessary to include a proxy routine 220 which is appropriately adapted to be called by the native interface 214. The proxy routine 220 simply accepts a call by the native interface 212 and makes a direct call to the software routine native code 218. Whilst the proxy routine 220 might receive arguments relating to a call by the native interface 214, these arguments are not propagated to the software routine native code 218. In this way the virtual machine 212 is able to call the software routine native code 218 using the native interface 214 through a proxy routine 220. However, this approach to calling the software routine native code 218 does involve a switch from the virtual machine context 204 to the native context 202 and so is not as efficient as the technique described above with respect to FIG. 3. The use of the native interface 214 is considered advantageous since it provides backwards compatibility with virtual machines 212 who do not implement the direct call technique.

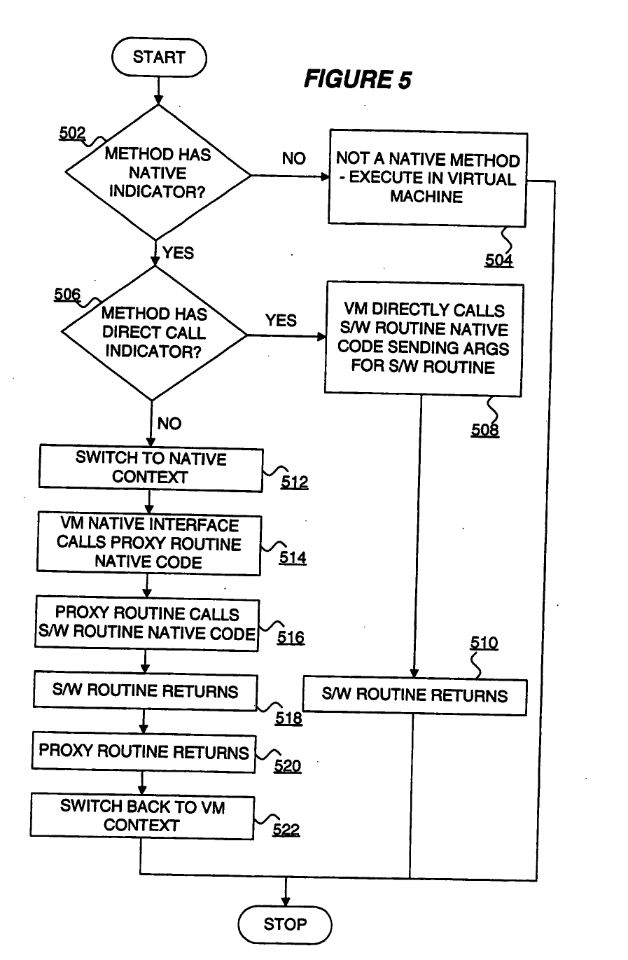

FIG. 5 is a flowchart illustrating a method for executing a native software routine in accordance with a preferred embodiment of the present invention. The method of FIG. 4 is implemented by the virtual machine 212 of FIGS. 2 to 4. At step 502 the method determines if a software method is implemented as a native software routine with reference to the native indicator 208. If the software method is not a native software routine the method proceeds to step 504 where the method is executed as bytecode in the virtual machine 212. Alternatively, if the software method is a native software routine the method proceeds to step 506. At step 506 the method determines if the software method is to be called directly by the virtual machine 212 with reference to the direct call indicator 210. If the software method is to be called directly by the virtual machine 212, the method proceeds to step 508 where the virtual machine 212 calls the software routine native code 218 directly sending any appropriate arguments. At step 510, on completion of execution of the software routine native code, the software routine returns and the method is complete. Alternatively, if at step 506 it was determined that the software method is not to be called directly by the virtual machine 212, the method proceeds to step 512. At step 512 the context switcher 216 switches the execution context from the virtual machine context 204 to the native context 202. At step 514 the virtual machine 212 uses the native interface 214 to calls the proxy routine 220. At step 516 the proxy routine 220 calls the software routine native code 218. At step 518 the software routine native code 218 returns and at step 520 the proxy routine returns. Finally, at step 522 the context switcher 216 switches the execution context back from the native context 202 to the virtual machine context 204 and the method is complete.

Thus, using the method of FIG. 5 the virtual machine 212 is able to call the software routine native code 218 either directly with no change of context, or through the native interface 214. The ability to call the software routine native code 218 without a change of context allows applications developers to use native code only where absolutely necessary whilst including application logic in bytecode (such as Java code). This further provides for more effective debugging of an application since substantive application logic can be contained within the application bytecode. Furthermore, the inclusion of the proxy routine 220 allows for the virtual machine 212 to call the software routine native code 218 using the native interface 214, such as the JNI. This provides backwards compatibility where a virtual machine 212 does not recognise the direct call indicator 210 or does not support the direct call method for calling a native software routine.

1. A method of executing a software routine in a virtual machine executing on a computer system, wherein the computer system can operate in one of a virtual machine execution context or a native execution context, the method comprising the steps of:
identifying a declaration of the software routine, the declaration including an indication that the software routine is to be executed in a native binary form;
responsive to a determination that the declaration of the software routine includes an indication that the software routine should be called directly by the virtual machine, the computer system operating in a virtual machine execution context and the virtual machine calling the software routine directly;
executing the software routine in a native binary form.

2. The method of claim 1 further comprising:
responsive to a determination that the declaration of the software routine does not include an indication that the software routine should be called directly by the virtual machine, the computer system operating in a native execution context, executing a proxy routine in a native binary form, wherein the proxy routine calls the software routine.

3. The method of claim 1 wherein the computer system operating in a native execution context includes the computer system switching from a virtual machine execution context to a native execution context.

4. The method of claim 1 wherein the software runtime environment is an object oriented runtime environment, and the software routine is a method of a class.

5. The method of claim 1 wherein the declaration of the software routine is stored in bytecode form.

6. The method of claim 1 wherein the declaration of the software routine includes a definition of a prototype of the software routine.

7. The method of claim 1 wherein the software routine is stored in a native library on the computer system.

8. The method of claim 2 wherein the proxy routine is stored in a native library on the computer system.

9. The method of claim 2 wherein, on execution of the proxy routine, the proxy routine is supplied with arguments relating to a state of the software runtime environment.

10. The method of claim 9 wherein the arguments relating to a state of the software runtime environment are not included in the call from the proxy routine to the software routine.

11. Apparatus for executing a software routine in a virtual machine executing on a computer system, wherein the computer system can operate in one of a virtual machine execution context or a native execution context, the apparatus comprising:
means for identifying a declaration of the software routine, the declaration including an indication that the software routine is to be executed in a native binary form;
means for responsive to a determination that the declaration of the software routine includes an indication that the software routine should be called directly by the virtual machine, the computer system operating in a virtual machine execution context and the virtual machine calling the software routine directly;
means for executing the software routine in a native binary form.

12. The apparatus of claim 11 further comprising:
means for responsive to a determination that the declaration of the software routine does not include an indication that the software routine should be called directly by the virtual machine, the computer system operating in a native execution context, executing a proxy routine in a native binary form, wherein the proxy routine calls the software routine.

13. The apparatus of claim 11 wherein the computer system operating in a native execution context includes the computer system switching from a virtual machine execution context to a native execution context.

14. The apparatus of claim 11 wherein the software runtime environment is an object oriented runtime environment, and the software routine is a method of a class.

15. The apparatus of claim 11 wherein the declaration of the software routine is stored in bytecode form.

16. The apparatus of claim 11 wherein the declaration of the software routine includes a definition of a prototype of the software routine.

17. The apparatus of claim 11 wherein the software routine is stored in a native library on the computer system.

18. The apparatus of claim 12 wherein the proxy routine is stored in a native library on the computer system.

19. The apparatus of claim 12 wherein, on execution of the proxy routine, the proxy routine is supplied with arguments relating to a state of the software runtime environment.

20. (canceled)

21. A computer program product comprising computer program code stored on a computer readable storage medium which, when executed on a data processing system, instructs the data processing system to carry out the method as claimed in claim 1.

22. (canceled)
